(19) United States
(12) Patent Application Publication
(10) Pub. No.: US 2013/0212519 A1
(43) Pub. Date: Aug. 15, 2013

(54) METHOD AND MOBILE TERMINAL FOR PRODUCING MOBILE APPLICATION

(71) Applicants: Yoon-Seop Chang, Daejeon (KR); Jae-Chul Kim, Daejeon (KR); Seong-Ho Lee, Daejeon (KR); Young-Jae Lim, Daejeon (KR)

(72) Inventors: Yoon-Seop Chang, Daejeon (KR); Jae-Chul Kim, Daejeon (KR); Seong-Ho Lee, Daejeon (KR); Young-Jae Lim, Daejeon (KR)

(73) Assignee: ELECTRONICS AND TELECOMMUNICATIONS RESEARCH INSTITUTE, Daejeon-city (KR)

(21) Appl. No.: 13/562,607

(22) Filed: Jul. 31, 2012

(30) Foreign Application Priority Data
Feb. 9, 2012 (KR) 10-2012-0013401

(51) Int. Cl. G06F 3/048

(52) U.S. Cl. 715/781

(57) ABSTRACT

Disclosed herein is a method and mobile terminal for producing a mobile application. In the method for producing a mobile application, a virtual extended work area having a size that is equal to or greater than a size of a screen of a mobile terminal is created. The virtual extended work area is divided to create a plurality of sectional work areas corresponding to a plurality of mobile application creation tools. An input is received from a user of the mobile terminal and then the plurality of sectional work areas are manipulated. A sectional work area corresponding to a current mobile application creation tool is displayed on the screen of the mobile terminal depending on manipulation of the plurality of sectional work areas.

### CROSS REFERENCE TO RELATED APPLICATION

This application claims the benefit of Korean Patent Application No. 10-2012-0013401, filed on Feb. 9, 2012, which is hereby incorporated by reference in its entirety into this application.

### BACKGROUND OF THE INVENTION

1. Technical Field

The present invention relates generally to a method and mobile terminal for producing a mobile application and, more particularly, to a method and mobile terminal for producing a mobile application, which create a virtual extended work area having a size that is equal to or greater than the screen size of the mobile terminal, divide the virtual extended work area to create a plurality of sectional work areas corresponding to a plurality of mobile application creation tools, and manipulate the sectional work areas, thus allowing a user to easily and efficiently produce a mobile application on the mobile terminal having a limited screen size.

2. Description of the Related Art

Mobile terminals such as smart phones or pads which have recently been released have a relatively limited screen size and resolution compared to a Personal Computer (PC). In addition, there are few examples of a system enabling applications, such as a native application, a web application, and a hybrid application, to be directly produced on a mobile terminal due to the limited performance of a component such as a Central Processing Unit (CPU) or a memory. In the case of mashups requiring various screens such as for the production of a user interface, the production of a workflow, and the input of metadata, there are few systems enabling such a mashup to be directly produced on a mobile terminal.

### SUMMARY OF THE INVENTION

Accordingly, the present invention has been made keeping in mind the above problems occurring in the prior art, and an object of the present invention is to provide a method and mobile terminal for producing a mobile application, which create a virtual extended work area having a size that is equal to or greater than the screen size of the mobile terminal, divide the virtual extended work area to create a plurality of sectional work areas corresponding to a plurality of mobile application creation tools, and manipulate the sectional work areas, thus allowing a user to easily and efficiently produce a mobile application on the mobile terminal having a limited screen size.

In accordance with an aspect of the present invention to accomplish the above object, there is provided a method for producing a mobile application, including creating a virtual extended work area having a size equal to or greater than that of a screen of a mobile terminal; dividing the virtual extended work area to create a plurality of sectional work areas corresponding to a plurality of mobile application creation tools; receiving an input from a user of the mobile terminal and then manipulating the plurality of sectional work areas; and displaying a sectional work area corresponding to a current mobile application creation tool on the screen of the mobile terminal depending on manipulation of the plurality of sectional work areas.

Preferably, the creating the virtual extended work area may be configured to create the virtual extended work area by a size of an entire work area including the plurality of sectional work areas.

Preferably, the creating the virtual extended work area may be configured to create the virtual extended work area by a size of each sectional work area.

Preferably, the method may further include previously creating and loading all sectional work areas other than an activated sectional work area to be displayed on the screen of the mobile terminal; and if any one of the sectional work areas other than the activated sectional work area is requested, displaying the requested sectional work area on the screen of the mobile terminal.

Preferably, the method may further include previously creating and loading sectional work areas adjacent to an activated sectional work area to be displayed on the screen of the mobile terminal; and if any one of the sectional work areas adjacent to the activated sectional work area is requested, displaying the requested sectional work area on the screen of the mobile terminal.

Preferably, the method may further include if any one of the plurality of sectional work areas is requested, creating and loading the requested sectional work area; and displaying the requested sectional work area on the screen of the mobile terminal.

Preferably, the manipulating the plurality of sectional work areas may be configured to perform one or more of manipulations including movement among sectional work areas, enlargement of each sectional work area, reduction of each sectional work area, selection of objects from each sectional work area, movement of objects, showing of context menus, and showing of an entire virtual extended work area, with respect to the plurality of sectional work areas.

Preferably, the plurality of sectional work areas may be configured such that one or more of a block User Interface (UI) production tool, a block code editor, a block metadata input tool, a block list, a mashup UI production tool, and a mashup workflow production tool are arranged in the sectional work areas.

In accordance with another aspect of the present invention to accomplish the above object, there is provided a mobile terminal for producing a mobile application, including a virtual extended work area creation unit for creating a virtual extended work area having a size equal to or greater than that of a screen of a mobile terminal; a sectional work area creation unit for dividing the virtual extended work area to create a plurality of sectional work areas corresponding to a plurality of mobile application creation tools; a manipulation unit for receiving an input from a user of the mobile terminal and then manipulating the plurality of sectional work areas; and a display unit for displaying a sectional work area corresponding to a current mobile application creation tool on the screen of the mobile terminal depending on manipulation of the plurality of sectional work areas.

Preferably, the virtual extended work area creation unit may be configured to create the virtual extended work area by a size of an entire work area including the plurality of sectional work areas.

Preferably, the virtual extended work area creation unit may be configured to create the virtual extended work area by a size of each sectional work area.

Preferably, the sectional work area creation unit may be configured to previously create and load all sectional work areas other than an activated sectional work area to be displayed on the screen of the mobile terminal, and the display unit may be configured to, if any one of the sectional work areas other than the activated sectional work area is requested, display the requested sectional work area on the screen of the mobile terminal.

Preferably, the sectional work area creation unit may be configured to previously create and load sectional work areas adjacent to an activated sectional work area to be displayed on the screen of the mobile terminal, and the display unit may be configured to, if any one of the sectional work areas adjacent to the activated sectional work area is requested, display the requested sectional work area on the screen of the mobile terminal.

Preferably, the sectional work area creation unit may be configured to, if any one of the plurality of sectional work areas is requested, create and load the requested sectional work area, and the display unit may display the requested sectional work area on the screen of the mobile terminal.

Preferably, the manipulation unit may be configured to perform one or more of manipulations including movement among sectional work areas, enlargement of each sectional work area, reduction of each sectional work area, selection of objects from each sectional work area, movement of objects, showing of context menus, and showing of an entire virtual extended work area, with respect to the plurality of sectional work areas.

Preferably, the plurality of sectional work areas may be configured such that one or more of a block User Interface (UI) production tool, a block code editor, a block metadata input tool, a block list, a mashup UI production tool, and a mashup workflow production tool are arranged in the sectional work areas.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a method for producing a mobile application according to an embodiment of the present invention;

FIG. 2 is a diagram showing an example in which the mobile application production method is implemented according to an embodiment of the present invention; and

FIG. 3 is a block diagram schematically showing a mobile terminal for producing a mobile application according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

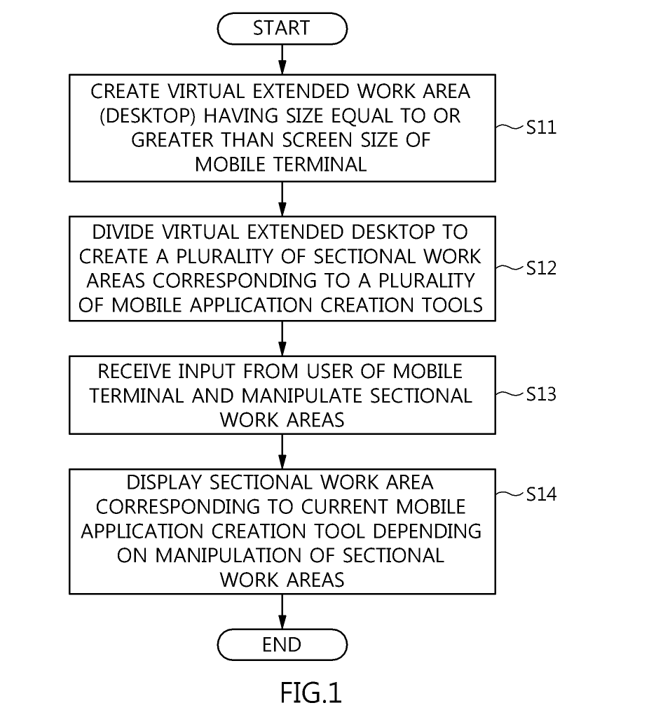

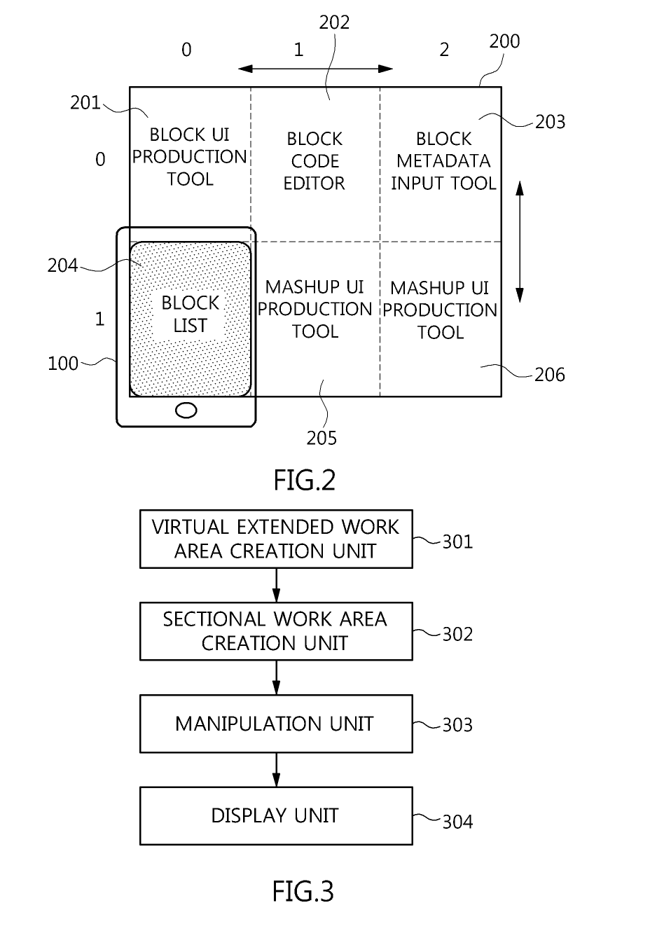

FIG. 1 is a flowchart showing a method for producing a mobile application according to an embodiment of the present invention, and FIG. 2 is a diagram showing an example in which the mobile application production method is implemented according to an embodiment of the present invention.

The mobile application production method according to the embodiment of the present invention is configured such that in order to facilitate the production of a mobile application on a mobile terminal having a limited screen size, a virtual extended work area having a size that is equal to or greater than the screen size of the mobile terminal is created, and user interactions such as multi-touch or touch on the mobile terminal are utilised, thus making it possible to move to one of sectional work areas of the virtual extended work area and enlarge or reduce a relevant sectional work area, and making it also possible to select a menu from each sectional work area or select or move objects on the screen.

The method for producing a mobile application according to the embodiment of the present invention will be described with reference to FIGS. 1 and 2. When the mobile application production method according to the embodiment of the present invention is initiated, a virtual extended work area 200 having a size that is equal to or greater than that of the screen of a mobile terminal 100 is created first at step S11. Further, the virtual extended work area 200 is divided to create a plurality of sectional work areas 201 to 206 corresponding to a plurality of mobile application creation tools at step S12.

A description will be made in detail with reference to FIG. 2. The virtual extended work area may be a virtual desktop in which sectional work areas, each having the same size as the screen size of the mobile terminal 100, are extended and arranged in an n×n (row×column) matrix form. In an embodiment of FIG. 2, a virtual extended work area 200 is shown in which sectional work areas 201 to 206 are arranged in a 2×3 matrix form. In this case, the sectional work area 201 at an upper left position of the matrix is an element (0, 0), and a sectional work area 206 at a lower right position of the matrix is an element (1, 2). In the individual sectional work areas 201 to 206 of the virtual extended work area 200, various tools necessary for the procedure of producing a mobile application are arranged. In an embodiment, as shown in FIG. 2, a block User Interface (UI) production tool, a block code editor, a block metadata input tool, a block list, a mashup UI production tool, and a mashup workflow production tool can be arranged as mobile mashup production tools in the sectional work areas 201, 202, 203, 204, 205, and 206, respectively.

The user can view a single sectional work area at a time on the screen of the mobile terminal 100 by moving the virtual extended work area 200 using a touch or drag action. In this way, a screen currently displayed on the screen of the mobile terminal 100 is called an “activated sectional work area.” In FIG. 2, the sectional work area 204 is the activated sectional work area. If necessary, the user can view two or more sectional work areas either simultaneously or by overlapping one another on the screen of the mobile terminal 100.

As described above, in order to display the sectional work areas 201 to 206 of the virtual extended work area 200 on the screen of the mobile terminal 100 to the user, the virtual extended work area 200 must be created. Here, the virtual extended work area 200 may be created by the size of the entire work area including all of the plurality of segmented work areas 201 to 206 or by the size of each sectional work area 201 to 206. The unit of the size for the creation of the virtual extended work area 200 can be differently selected depending on individual embodiments.

Further, in the case of an activated sectional work area to be displayed on the screen of the mobile terminal 100, time points at which the activated sectional work area is to be created and loaded can also be differently selected depending on individual embodiments. The activated sectional work area of the virtual extended work area 200 can be created and loaded in real time at a time point at which the activated sectional work area is to be displayed. Alternatively, all sectional work areas other than the currently activated sectional work area can be previously created, loaded, and prepared, and can be displayed to the user when a request is received. Alternatively, only sectional work areas adjacent to a currently activated sectional work area can be previously created, loaded, and prepared, and can be displayed to the user when a request is received.

Referring back to FIG. 1, after the virtual extended work area 200 has been divided to create the plurality of sectional work areas 201 to 206 corresponding to the plurality of mobile application creation tools at step S12, an input is received from the user of the mobile terminal and then the plurality of sectional work areas are manipulated at step S13. Further, a sectional work area corresponding to a current mobile application creation tool is displayed on the screen of the mobile terminal depending on the manipulation of the plurality of sectional work areas at step S14. That is, the input is received from the user of the mobile terminal and the plurality of sectional work areas are manipulated, so that an activated sectional work area is displayed on the screen of the mobile terminal.

In this case, movement among the sectional work areas 201 to 206 of the virtual extended work area 200 can be performed via interactions such as the multi-touch, touch, or mode toggle of the user according to the type of mobile terminal 100. For example, the virtual extended work area is mainly manipulated using the multi-touch interaction of the user in the case of Apple's iPhone that supports a multi-touch function, and using mode toggle and a touch interaction in the case of an Android phone that does not support a multi-touch function.

When a multi-touch function is used as in the case of Apple's iPhone, various functions such as movement among the sectional work areas of the virtual extended work area 200, the enlargement of each sectional work area, the reduction of each sectional work area, the selection of objects (including a menu) from each sectional work area, the movement of objects, the showing of context menus, and the showing of the entire virtual extended work area can be executed by combining the number of touch points such as for one-point touch, two-point touch, and three-point touch, click and double click interactions, and a drag interaction.

When a multi-touch function cannot be used as in the case of an Android phone, functions identical to the above functions can be executed by combining mode toggle and a touch interaction. Here, the term “mode toggle” refers to the setup of a mode for movement among sectional work areas, a mode for the enlargement/reduction of sectional work areas, an object control mode, etc., instead of one-point touch, two-point touch, three-point touch, etc. in the case of the multi-touch function. Such mode toggle can be set using a menu screen or by pressing a specific button on the mobile terminal. Various functions such as movement among the sectional work areas of the virtual extended work area, the enlargement of each sectional work area, the reduction of each sectional work area, the selection of objects (including a menu) from each sectional work area, the movement of objects, the showing of context menus, and the showing of the entire virtual extended work area can be executed by combining such mode toggle, click and double-click interactions, and a drag interaction.

In this way, the user allows a tool that is desired to be used to be displayed in the activated sectional work area by moving the sectional work areas 201 to 206, and produces a mobile application by manipulating objects displayed in the activated sectional work area.

The above mobile application production method has been described with reference to the flowchart presented in the drawing. Although the steps of the method have been described as being a series of blocks for the sake of simplicity of explanation, the present invention is not limited by the sequence of the blocks, and several blocks may occur either in a sequence different from that shown and described in the present specification with respect to other blocks, or simultaneously with other blocks. Further, a variety of different branches, flow paths, and block sequences that achieve results identical or similar to those of the present specification may be implemented. Furthermore, all blocks shown in the implementation of the method described in the present specification may not necessarily be required.

FIG. 3 is a diagram schematically showing a mobile terminal for producing a mobile application according to an embodiment of the present invention.

Referring to FIG. 3, the mobile terminal for producing a mobile application according to the embodiment of the present invention may include a virtual extended work area creation unit 301, a sectional work area creation unit 302, a manipulation unit 303, and a display unit 304. The configuration of the mobile terminal of FIG. 3 for producing a mobile application depends on an embodiment, all blocks shown in FIG. 3 are not essential elements, and some blocks may added, changed, or deleted in other embodiments.

The virtual extended work area creation unit 301 creates a virtual extended work area having a size that is equal to or greater than the screen size of the mobile terminal. In an embodiment, the virtual extended work area creation unit 301 may create the virtual extended work area by the size of the entire work area including a plurality of sectional work areas, or by the size of each sectional work area.

The sectional work area creation unit 302 divides the virtual extended work area to create the plurality of sectional work areas corresponding to a plurality of mobile application creation tools. In an embodiment, the sectional work area creation unit 302 may previously create and load all sectional work areas other than an activated sectional work area to be displayed on the screen of the mobile terminal, or may previously create and load sectional work areas adjacent to an activated sectional work area to be displayed on the screen of the mobile terminal.

The manipulation unit 303 receives an input from the user of the mobile terminal and then manipulates the plurality of sectional work areas. In an embodiment, the manipulation unit 303 may perform one or more of various manipulations that include movement among sectional work areas, the enlargement of each sectional work area, the reduction of each sectional work area, the selection of objects from each sectional work area, the movement of objects, the showing of context menus, and the showing of the entire virtual extended work area, with respect to the plurality of sectional work areas.

The display unit 304 displays a sectional work area corresponding to a current mobile application creation tool on the screen of the mobile terminal depending on the manipulation of the plurality of sectional work areas. In an embodiment, when the sectional work area creation unit 302 previously creates and loads all sectional work areas other than an activated sectional work area to be displayed on the screen of the mobile terminal, the display unit 304 may display a requested sectional work area on the screen of the mobile terminal when any one of the sectional work areas other than the activated sectional work area is requested. Alternatively, when the sectional work area creation unit 302 previously creates and loads sectional work areas adjacent to an activated sectional work area to be displayed on the screen of the mobile terminal, the display unit 304 may display a requested sectional work area on the screen of the mobile terminal when any one of the sectional work areas adjacent to the activated sectional work area is requested. Alternatively, when the sectional work area creation unit 302 does not previously create and load sectional work areas and any one of a plurality of sectional work areas is requested, the sectional work area creation unit 302 creates and loads the requested sectional work area. The display unit 304 may display the requested sectional work area on the screen of the mobile terminal.

The mobile terminal for producing a mobile application according to the embodiment of the present invention performs operations similar to those of the mobile application production method of FIGS. 1 and 2 according to the embodiment of the present invention, so that the description of FIGS. 1 and 2 is equally applied to the mobile terminal unless a special description is given, and thus a detailed description thereof will be omitted.

In accordance with an aspect of the present invention, there can be provided a method and mobile terminal for producing a mobile application, which create a virtual extended work area having a size that is equal to or greater than the screen size of the mobile terminal, divide the virtual extended work area to create a plurality of sectional work areas corresponding to a plurality of mobile application creation tools, and manipulate the sectional work areas, thus allowing a user to easily and efficiently produce a mobile application on the mobile terminal having a limited screen size.

Accordingly, the method and mobile terminal for producing a mobile application in accordance with an aspect of the present invention allows even a normal user as well as an expert or a developer to easily access and use the production of mobile applications, thus greatly contributing to the expansion of popularization of mobile applications and creation of profits.

In particular, the method and mobile terminal for producing a mobile application in accordance with an aspect of the present invention can be very usefully applied to mashups which require various types of screens, such as the production of a User Interface (UI), the production of a workflow, and the input of metadata.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. These modifications, additions and substitutions should be interpreted as being included in the claims of the present invention without departing from the scope of the present invention.

What is claimed is:

1. A method for producing a mobile application, comprising:
creating a virtual extended work area having a size equal to or greater than size of a screen of a mobile terminal;
creating a plurality of sectional work areas corresponding to a plurality of mobile application creation tools by dividing the virtual extended work area;
receiving an input from a user of the mobile terminal and then manipulating the plurality of sectional work areas; and
displaying a sectional work area corresponding to a current mobile application creation tool on the screen of the mobile terminal, depending on manipulation of the plurality of sectional work areas.

2. The method of claim 1, wherein the creating the virtual extended work area is configured to create the virtual extended work area by a size of an entire work area including the plurality of sectional work areas.

3. The method of claim 1, wherein the creating the virtual extended work area is configured to create the virtual extended work area by a size of each sectional work area.

4. The method of claim 1, further comprising:
previously creating and loading all sectional work areas other than an activated sectional work area to be displayed on the screen of the mobile terminal; and
if any one of the sectional work areas other than the activated sectional work area is requested, displaying the requested sectional work area on the screen of the mobile terminal.

5. The method of claim 1, further comprising:
previously creating and loading sectional work areas adjacent to an activated sectional work area to be displayed on the screen of the mobile terminal; and
if any one of the sectional work areas adjacent to the activated sectional work area is requested, displaying the requested sectional work area on the screen of the mobile terminal.

6. The method of claim 1, further comprising:
if any one of the plurality of sectional work areas is requested, creating and loading the requested sectional work area; and
displaying the requested sectional work area on the screen of the mobile terminal.

7. The method of claim 1, wherein the manipulating the plurality of sectional work areas is configured to perform at least one of manipulations including movement among sectional work areas, enlargement of each sectional work area, reduction of each sectional work area, selection of objects from each sectional work area, movement of objects, showing of context menus, and showing of an entire virtual extended work area, with respect to the plurality of sectional work areas.

8. The method of claim 1, wherein the plurality of sectional work areas are configured such that at least one of a block User Interface (UI) production tool, a block code editor, a block metadata input tool, a block list, a mashup UI production tool, and a mashup workflow production tool are arranged in the sectional work areas.

9. A mobile terminal for producing a mobile application, comprising:
a virtual extended work area creation unit for creating a virtual extended work area having a size equal to or greater than size of a screen of a mobile terminal;
a sectional work area creation unit for creating a plurality of sectional work areas corresponding to a plurality of mobile application creation tools, by dividing the virtual extended work area;
a manipulation unit for receiving an input from a user of the mobile terminal and then manipulating the plurality of sectional work areas; and
a display unit for displaying a sectional work area corresponding to a current mobile application creation tool on the screen of the mobile terminal depending on manipulation of the plurality of sectional work areas.

10. The mobile terminal of claim 9, wherein the virtual extended work area creation unit is configured to create the virtual extended work area by a size of an entire work area including the plurality of sectional work areas.

11. The mobile terminal of claim 9, wherein the virtual extended work area creation unit is configured to create the virtual extended work area by a size of each sectional work area.

12. The mobile terminal of claim 9, wherein:
the sectional work area creation unit is configured to previously create and load all sectional work areas other than an activated sectional work area to be displayed on the screen of the mobile terminal, and
the display unit is configured to, if any one of the sectional work areas other than the activated sectional work area is requested, display the requested sectional work area on the screen of the mobile terminal.

13. The mobile terminal of claim 9, wherein:
the sectional work area creation unit is configured to previously create and load sectional work areas adjacent to an activated sectional work area to be displayed on the screen of the mobile terminal, and
the display unit is configured to, if any one of the sectional work areas adjacent to the activated sectional work area is requested, display the requested sectional work area on the screen of the mobile terminal.

14. The mobile terminal of claim 9, wherein:
the sectional work area creation unit is configured to, if any one of the plurality of sectional work areas is requested, create and load the requested sectional work area, and
the display unit displays the requested sectional work area on the screen of the mobile terminal.

15. The mobile terminal of claim 9, wherein the manipulation unit is configured to perform at least one of manipulations including movement among sectional work areas, enlargement of each sectional work area, reduction of each sectional work area, selection of objects from each sectional work area, movement of objects, showing of context menus, and showing of an entire virtual extended work area, with respect to the plurality of sectional work areas.

16. The mobile terminal of claim 9, wherein the plurality of sectional work areas are configured such that at least one of a block User Interface (UI) production tool, a block code editor, a block metadata input tool, a block list, a mashup UI production tool, and a mashup workflow production tool are arranged in the sectional work areas.
